(19) United States
(12) Patent Application Publication
(10) Pub. No.: US 2010/0196596 A1
(43) Pub. Date: Aug. 5, 2010

(54) DOUBLE-SIDED COATING APPARATUS AND METHOD FOR DOUBLE-SIDED COATING WITH COATING SOLUTION

(75) Inventors: Katsumasa Hirose, Ichihara-shi (JP); Akira Sakawaki, Ichihara-shi (JP); Masato Fukushima, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: Showa Denko K.K., Minato-ku, Tokyo (JP)

(21) Appl. No.: 12/677,704

(22) PCT Filed: Sep. 12, 2008
(86) PCT No.: PCT/JP2008/066569

§ 371 Date: Mar. 11, 2010

(30) Foreign Application Priority Data
Sep. 14, 2007 (JP) 2007-239535
Sep. 14, 2007 (JP) 2007-239536
Sep. 14, 2007 (JP) 2007-239537

(51) Int. Cl. B05D 1/02; B05C 5/00; B05C 11/02

(52) U.S. Cl. 427/209; 118/52

(57) ABSTRACT

Provided are a double-sided coating apparatus and a method for double-sided coating with a coating solution configured to uniformly apply a coating solution to both surfaces of a substrate having a central opening in a simple process while preventing ingress of the coating solution to the central opening. A coating apparatus 1 according to the invention applies a coating solution to both main surfaces of a substrate 2 having a central opening 2a. The coating apparatus 1 includes: a rotation driving mechanism 3 with a chuck 11 which holds the substrate 2 by blocking the central opening 2a; a first coating solution nozzle 18 which ejects a coating solution to a first main surface of the substrate 2; a first pivot driving mechanism 17 which operates the first coating solution nozzle 18 to move to scan the first main surface of the substrate 2; a second coating solution nozzle 28 which ejects the coating solution to a second main surface of the substrate 2; a second pivot driving mechanism 31 which operates the second coating solution nozzle 28 to move to scan the second main surface of the substrate 3, and a device to independently control an ejection amount of the coating solution from the first coating solution ejection port 23 and an ejection amount of the coating solution from the second coating solution ejection port 29.

### TECHNICAL HELD

The present invention relates to a coating apparatus and a method for double-sided coating with a coating solution. More particularly, the invention relates to a double-sided coating apparatus and a method for double-sided coating with a coating solution suitable for applying a coating solution to both main surfaces of a substrate which has a central opening.

### BACKGROUND ART

Recently, applicability of magnetic recording devices, such as magnetic disk devices, flexible disk devices and magnetic tape devices, have increased significantly and their importance has also increased. Recording density of magnetic recording media used for these devices has been increased significantly. With the advent of a magnetoresistive (MR) head and partial response maximum likelihood (PRIM.) technology, surface recording density has improved still more significantly. In recent years, recording heads, such as giant magnetoresistive (GMR) heads and tunnel magnetoresistive (TMR) heads, have also been introduced, which further increase the surface recording density by about twice a year. There is a demand to farther increase recording density of these magnetic recording media. It is therefore necessary to increase coercive force, a signal-to-noise ratio (SNR) and resolution of magnetic recording layers. In recent years, efforts have been made to increase surface recording density by increasing linear recording density and track density.

The most recent magnetic recording media have track density of as high as 110 kTPI. As the track density increases, however, magnetic recording information between adjacent tracks begins interfering with each other, which may easily cause a problem that a magnetizing transition area of a border area becomes a noise source that decreases the SNR. The decrease in the SNR causes a decrease in a bit error rate, which is an obstacle to an improvement in magnetic recording density of a magnetic recording medium.

In order to increase surface recording density, it is necessary to provide reduced-sized recording bits on the magnetic recording medium, each recording bit having maximum possible saturation magnetization and maximum possible magnetic film thickness. There is a problem, however, that the reduced-sized recording bit has a small magnetizing minimum volume per 1 bit and recorded data may disappear due to flux reversal caused by heat fluctuation.

Since adjacent tracks are close to each other, a significantly precise track servo technique is necessary for a magnetic recording device. Usually, data is recorded in a larger number of tracks and reproduced in a smaller number of tracks in order to prevent the influence from adjacent tracks as much as possible. In this manner, however, although the influence between the tracks can be controlled to the minimum, it is difficult to obtain a sufficient reproduction output and thus to provide a sufficient SNR.

In order to avoid a heat fluctuation problem, provide a sufficient SNR and to provide sufficient output, an attempt has been made to form an uneven configuration along the track on, the surface of the magnetic recording medium so as to physically separate the recording tracks from one another to increase the track density. Hereinafter, such a technique is called a discrete track process and a magnetic recording medium produced thereby is called a discrete track medium.

An exemplary discrete track medium is a magnetic recording medium. The magnetic recording medium is formed on a non-magnetic substrate on which an uneven pattern is formed. A physically-separated magnetic recording track and a servo signal pattern are formed on the magnetic recording medium (see, for example, Patent Document 1).

The disclosed magnetic recording medium includes a ferromagnetic layer formed on an uneven surface of a substrate via a soft magnetic layer. A protective film is formed on the surface of the ferromagnetic layer. The magnetic recording medium has, in its projecting area, a magnetic recording area which is physically separated from the surrounding areas.

In the disclosed magnetic recording medium, since formation of a magnetic wall in the soft magnetic layer can be avoided and influence of the heat fluctuation can be prevented, there is no interference between adjacent signals. Thus, a high-density magnetic recording medium with less noise can be provided.

The discrete track process includes forming tracks after a magnetic recording medium consisting of several thin film layers is formed or forming an uneven pattern directly on a substrate surface or on a thin film layer for forming tracks and then forming a thin magnetic recording medium film (see, for example, Patent Documents 2 and 3), The former process, a magnetic layer process, has a following problem. Since physical processing is made to a surface of a finished medium, the medium is easily contaminated during the manufacturing process and the manufacturing process becomes significantly complicated.

The latter process, an embossing process, also has a following problem. Although the medium is not easily contaminated during the manufacturing process, since an uneven configuration formed on a substrate is taken over to a film formed thereon, levitation pose and levitation height of a head which records onto and reproduces from a medium become unstable.

The following substrate coating apparatus is known. A disc-shaped substrate is held along a vertical plane and is rotated in a circumferential direction. The rotating substrate is moved vertically with respect to a coating vessel containing a solution material and is immersed in the solution material. After that, the substrate is lifted off the solution material and an excessive solution material adhering to the substrate is spun off. In this manner, a uniform layer can be provided (see Patent Document 4).

The following resist coating apparatus is also known. A disc-shaped wafer is held at an outer peripheral portion thereof with pawls to be rotated horizontally, Nozzles are provided above and below a wafer substrate and resist is applied to upper and lower surfaces of the rotating substrate (see Patent Document 5). In the disclosed resist coating apparatus, a resist solution is spun off the rotating wafer.

[Patent Document 1] Japanese Unexamined Patent Application, First Publication No. 2004-164692

[Patent Document 2] Japanese Unexamined Patent Application, First Publication No. 2004-178793

[Patent Document 3] Japanese Unexamined Patent Application, First Publication No. 2004-178794

[Patent Document 4] Japanese Unexamined Patent Application, First Publication No. 2004-306032

[Patent Document 5] Japanese Unexamined Patent Application, First Publication No. H7-245255

### DISCLOSURE OF NVENTION

In order to solve the problems regarding the discrete track process described above, the present inventors studied intensively and found that the magnetic recording tracks can be magnetically separated from one another when a finished magnetic layer is exposed to reactive plasma at a portion in which neither magnetic recording tracks nor servo signal patterns (i.e., magnetic recording patterns) are formed.

In particular, in this method, the resist is applied to an entire magnetic layer, a formed resist layer is patterned in accordance with a magnetic recording pattern and then the magnetic layer is exposed to reactive plasma. In this manner, magnetic property of the magnetic layer is modified at a portion in which no resist layer is formed and the magnetic recording tracks on the magnetic layer are separated magnetically from one another.

Since no uneven configuration is formed in the method studied by the inventors, a discrete track medium can be manufactured in a simple process while avoiding contambiation of the medium that should have been caused by an uneven configuration. Since the obtained discrete track medium has no uneven configuration, a levitation head can make a stable levitation travel.

In the method described above, it is necessary to apply the resist to an entire surface of the magnetic layer.

Since a magnetic recording medium (i.e., a magnetic disk) incorporated in a magnetic disk device has magnetic layers on both surfaces, it is necessary to apply the resist to both surfaces. Related art resist coating apparatuses used widely in semiconductor processes or other processes, however,. are designed to apply the resist only to one surface of a substrate. If the resist is to be applied to both surfaces of a substrate with such coating apparatuses, a resist application process should be repeated twice. Such repetition requires an increased number of steps and takes a longer time for the resist application process.

A magnetic disk has a central opening to be held by a magnetic disk device. If foreign substances, such as resist, exist in the central opening, a holding position of the magnetic disk becomes unclear and the magnetic disk itself and a chuck may be contaminated. Since the related art coating apparatus described above is configured to apply the resist to the entire surface of the disc-shaped substrate, the resist may enter the central opening during application of the resist to the disc-shaped substrate. It is therefore possible that the resist applied to the central opening cannot be completely removed in post processes and remains in the central opening of a finished magnetic disk.

In view of these circumstances, it is highly possible that the solution material is applied to the central opening of the substrate in the coating apparatus disclosed in Patent Document 4 which has a mechanism to vertically move a substrate supported along a vertical plane to immerse in a solution material, although the solution material can be applied to both surfaces of the substrate at the same time. The resist coating apparatus disclosed in Patent Document 5 is designed to apply a solution to a semiconductor wafer having no central opening. No consideration has been made regarding the aforementioned problems during application of a resist solution to a substrate with a central opening although the resist solution can be applied to both the upper and lower surfaces of the substrate.

The invention is made in view of the aforementioned circumstances and an object thereof is to provide a double-sided coating apparatus and a method for double-sided coating with a coating solution configured to uniformly apply a coating solution to both surfaces of a substrate having a central opening in a simple process while preventing ingress of the coating solution to the central opening.

### MEANS FOR SOLVING THE PROBLEMS

In order to solve the aforementioned problems, the inventors intensively studied and completed the invention.

(1) A double-sided coating apparatus according to the invention used to form a coating layer on both main surfaces of a substrate with a central opening by supplying a coating solution to the main surfaces, operating the substrate to rotate and causing the coating solution to spread out on the main surfaces, the apparatus including:

a rotation driving mechanism which includes a holding mechanism for holding the substrate at the central opening, the rotation driving mechanism driving the substrate to rotate in a circumferential direction;

a first solution coating unit which includes a first coating solution nozzle through which the coating solution is ejected to a first main surface of the substrate and a moving mechanism for the first coating solution nozzle which operates the first coating solution nozzle to move so that a coating solution ejection port of the nozzle is moved to scan the first main surface while being kept away from the first main surface; and

a second solution coating unit which includes a second coating solution nozzle through which the coating solution is ejected to a second main surface of the substrate and a moving mechanism for the second coating solution nozzle which operates the second coating solution nozzle to move so that a coating solution ejection port of the nozzle is moved to scan the second main surface while being kept away from the second main surface.

(2) The double-sided coating apparatus according to the invention further includes a device to close the central opening of the substrate to prevent ingress of the coating solution to the central opening when the substrate is held by the holding mechanism recited in (1).

(3) The double-sided coating apparatus according to (1) or (2) further includes a control section for controlling an operation of the rotation driving mechanism, the first solution coating unit or the second solution coating unit, in which the control section has a device to control the first coating solution nozzle operated by the moving mechanism for the first coating solution nozzle and the second coating solution nozzle operated by the moving mechanism for the second coating solution nozzle to eject the coating solution only to outside of an inner peripheral edge of the substrate held by the holding mechanism without ejecting the coating solution to the central opening of the substrate.

(4) The double-sided coating apparatus according to any one of (1) to (3) further includes a control section for controlling an operation of the rotation driving mechanism, the first solution coating unit or the second solution coating unit, in which the control section has a device to independently control an ejection amount of the coating solution from the first coating solution nozzle and an ejection amount of the coating solution from the second coating solution nozzle.

(5) The double-sided coating apparatus according to the invention is characterized in that the control section recited in (4) has a device to independently control the ejection amount of the coating solution from the first coating solution nozzle and a scan speed of the coating solution ejection port of that nozzle and the ejection amount of the coating solution from the second coating solution nozzle and a scan speed of the coating solution ejection port of that nozzle.

(6) The double-sided coating apparatus according to the invention is characterized in that: the first solution coating unit recited in any one of (1) to (5) further includes, around the holding mechanism, a first nozzle pivot arm which supports the first coating solution nozzle; the second solution coating unit further includes, around the holding mechanism, a second nozzle pivot arm which supports the second coating solution nozzle; and the first and second coating solution nozzles are supported so that the coating solution ejection ports thereof face each of the main surfaces of the substrate as the first and the second pivot arms pivot along a surface parallel to the substrate.

(7) The double-sided coating apparatus according to the invention is characterized in that: the first nozzle pivot arm and the second nozzle pivot arm recited in any one of (1) to (6) are disposed symmetrically about the holding mechanism; and the coating solution ejection port of the first nozzle pivot arm and the coating solution ejection port of the second nozzle pivot arm are independently supported so as to be moved from an inner peripheral edge of the central opening of the substrate to an outer peripheral edge of the substrate.

(8) The double-sided coating apparatus according to any one of (1) to (6) further includes a cup housing disposed to surround the substrate and the holding mechanism holding the substrate, in which the cup housing is moved close to or away from the substrate with an opening thereof facing the substrate and is moved between a non-housing position in which the opening of the cup housing is kept away from the substrate and a housing position in which the substrate is housed in the cup housing.

(9) The double-sided coating apparatus according to the invention is characterized in that:

the first and second coating solution nozzles are provided to extend from outside the cup housing recited in (8) so that coating solution ejection ports at their distal ends face the substrate; and

the distal end of the first coating solution nozzle and the distal end of the second coating solution nozzle are bent so that the first and second coating solution nozzles can be made to scan with the coating solution ejection ports at the distal ends thereof being close to the substrate through the opening of the cup housing when the cup housing is in a housing position in. which the substrate is housed.

(10) The double-sided coating apparatus according to the invention further includes a cover for closing the opening of the cup housing recited in (8) or (9) via a slight clearance, the cover being moved close to or away from the cup housing in a state in which the substrate is housed in the cup housing and the coating solution ejection ports at the distal ends of the first and second coating solution nozzles are made to extend to face the substrate.

(11) The double-sided coating apparatus according to the invention is characterized in that, in a state in which a discharge pipe is connected to a bottom of the cup housing recited in any one of (8) to (10) and the opening of the cup housing is closed with the cover via a slight clearance, air is sucked from outside into the cup housing through the clearance to generate an air flow from the opening toward the bottom of the cup housing.

(12) The double-sided coating apparatus according to the invention further includes a spreading-out slope plate disposed at an inner peripheral side of the opening of the cup housing recited in any one of (8) to (11) for guiding the flow of air sucked through the housing through the opening.

(13) The double-sided coating apparatus according to the invention is characterized in that: a rotation axis of the rotation driving Mechanism penetrates the cup housing recited in any one of (8) to (12) at a bottom center thereof; an air suction clearance is formed between the rotation axis and the bottom of the cup housing; a discharge pipe is connected to the bottom of the cup housing at an outer peripheral side thereof; an umbrella-shaped air control section is provided at the rotation axis to surround the clearance; and an outward air flow is generated along the bottom of the cup housing from the air suction clearance toward the discharge pipe.

(14) The double-sided coating apparatus according to any one of (1) to (13) is characterized in that:

the first solution coating unit further includes, adjacent to the first coating solution nozzle, a first rinsing solution nozzle for rinsing the coating solution applied to the substrate and the second solution coating unit further includes, adjacent to the second coating solution nozzle, a nozzle for a second rinsing solution for rinsing the coating solution applied to the substrate; and

these nozzles for the first and second rinsing solutions are provided to be movable along one of the first and second main surfaces of the substrate and the coating layers on the substrate are partially rinsed and removed by the rinsing solution ejected from the nozzles for the first and second'rinsing solutions.

(15) The double-sided coating apparatus according to the invention is characterized in that, the rinsing solution is ejected in an angled direction toward an outer peripheral edge of the first main surface of the substrate through the rinsing solution ejection port in a state in which the distal end of the first rinsing solution nozzle recited in (14) faces the first main surface of the substrate held by the holding mechanism, and the rinsing solution is ejected in an angled direction toward the outer peripheral edge of the second main surface of the substrate through the rinsing solution ejection port in a state in which the first rinsing solution nozzle faces the second main surface of the substrate held by the holding mechanism.

(16) A method for double-sided coating with a coating solution for forming coating layers on both main surfaces of a substrate with a central opening by supplying a coating solution to the main surfaces, operating the substrate to rotate and causing the coating solution to spread out on the main surfaces, the method including:

forming the coating layers on both the main surfaces of the substrate by keeping the substrate horizontally, ejecting a coating solution to both the main surfaces of the substrate . from a first coating solution nozzle through which the coating solution is ejected to a first main surface of the substrate and a second coating solution nozzle through which the coating solution is ejected to a second main surface of the substrate and making the substrate rotate; and then

ejecting a rinsing solution to thick portions of the coating layers formed at an outer peripheral edge of the substrate from a first rinsing solution nozzle through which the rinsing solution is ejected to the first main surface and a second rinsing solution nozzle through which the rinsing solution is ejected to the second main, surface and making the substrate rotate so that the thick portions of the coating layers are partially removed together with the rinsing solution to provide the coating layers of uniform thickness.

(17) The method for double-sided coating with a. coating solution according to the invention is characterized in that, in a state in which both of a rinsing solution ejection port of the first rinsing solution nozzle recited in (16) and a rinsing solution ejection port of the second rinsing solution nozzle are positioned inside of the outer peripheral edge of the substrate, the rinsing solution is ejected in an angled direction from an inner peripheral portion toward the outer peripheral edge of the substrate and the rinsing solution is placed on the coating layers, and then the substrate is made to rotate so that the thick portions of the coating layers at the outer peripheral edge of the substrate are partially removed.

(18) The method for double-sided coating with a coating solution according the invention is characterized in that the coating solution is ejected from the first and second coating solution nozzles with the substrate recited in (16) or (17) being kept horizontally and the central opening of the substrate being closed to prevent ingress of the coating solution.

According to the invention, the coating apparatus includes a first coating solution nozzle which ejects the coating solution to the first main surface and a second coating solution nozzle which ejects the coating solution to the second main surface. The coating solution can be supplied to both the main surfaces of the substrate at the same time. With this configuration, as compared with related art apparatuses in which the coating solution should be supplied to the first main surface and, subsequently, to the second main surface of the substrate, the coating solution can be applied to both the main surfaces of the substrate at the same time in a short time and in a simple process to form coating layers.

The substrate which is held and rotated by the holding mechanism may be surrounded by the movable cup housing or may be released. When the substrate is made to rotate with the coating solution applied thereon to form coating layers, the coating solution is spun off the rotating substrate within the cup housing. Such a configuration prevents contamination of a surrounding area. Since the substrate can be released when the cup housing is moved away from the substrate, the substrate can be removed and replaced easily.

The first coating solution nozzle and the second coating solution nozzle are provided to extend from outside of the cup housing. These nozzles can be made to scan the substrate with the coating solution ejection ports at distal ends of thereof facing the substrate. With this configuration, the coating solution is ejected from the coating solution ejection ports of the first and second coating solution nozzles to both the surfaces of the substrate to provide the coating layers in a state in which the substrate is surrounded by the cup housing.

The ejection amount of the coating solution from the coating solution ejection port of the first coaling solution nozzle and the ejection amount of the coating solution from the coating solution ejection port of the second coating solution nozzle can be controlled independently. The ejection amount of the coating solution can be controlled to provide coating layers of the same thickness at both main surfaces of the substrate even if the upper and lower main surfaces have a different amount of the coating solution applied and different thickness of the coating layer when the substrate is driven to rotate with either the main surfaces being the upper or the lower surfaces. With this configuration, the coating layers of the same thickness can be formed through simultaneous double-sided application of the coating solution to the substrate.

The ejection amount of the coating solution, the scan speed of the first coating solution ejection port, the ejection amount of the coating solution and the scan speed of the second coating solution ejection port can be controlled independently. Thus, the ejection amount of the coating solution can be controlled to provide coating layers of the same thickness at both main surfaces of the substrate even if the upper and lower main surfaces have a different amount of the coating solution applied and different thickness of the coating layer when the substrate is driven to rotate with either the main surfaces being the upper or the lower surfaces. It is also possible that rotation of the substrate can be controlled to provide coating layers of the same thickness at both main surfaces of the substrate. With this configuration in which rotation of the substrate is also controlled in addition to the ejection amount of the coating solution, controllability of the thickness of the coating layers formed on the substrate is further enhanced.

The cup housing includes a cover disposed outside the cup housing via a certain clearance. Such a configuration prevents escaping of the coating solution through the opening of the cup housing.

During the formation of the coating layers, the substrate may be rotated while an air flow is generated from the opening of the cup housing toward a bottom of the cup housing. In this manner, the coating layers can be dried uniformly and easily.

A slope plate may be provided in the cup housing to guide the air fiow. With the slope plate, a stable air flow can be formed easily to efficiently dry the coating layer.

A clearance is formed at a bottom central portion of the cup housing between the cup housing and a rotation axis penetrating the same. Air is sucked through the clearance to generate an outward air flow along the bottom of the cup housing. An air flow from the opening of the cup housing toward the bottom of the cup housing and the outward air flow along the bottom of the cup housing are merged to provide a uniform air flow inside the cup housing. With this configuration, the substrate can be dried uniformly.

The first and second rinsing solution nozzles are provided in addition to the first and second coating solution nozzles. With this configuration, after the coating layers axe formed on both the surfaces of the substrate with the ejected coating solution, the rinsing solution is ejected from the first and second rinsing solution nozzles to the coating layers so as to partially rinse the coating layers. Thus, the thickness of the formed coating layers can be controlled partially.

When a coating solution of high viscosity is ejected to the substrate, the coating layers formed after rotation of the substrate tend to be thicker at an outer peripheral edge of the substrate. In this case, the coating layers can be partially removed at the outer peripheral edge of the substrate by ejecting the rinsing solution from the first and second rinsing solution nozzles at the outer peripheral edge of the substrate and then making the substrate rotate. in this manner, the coating layers have a uniform thickness from an inner peripheral side to an outer peripheral side.

In the coating apparatus according to the invention, the holding mechanism which holds the substrate has a device to close the central opening of the substrate. Such a configuration prevents ingress of the coating solution to the central opening of the substrate during application of the coating solution. It is therefore possible to form coating layers, such as resist layers, on the surfaces except for the central opening.

Accordingly, if a non-magnetic substrate of a magnetic recording medium is employed as a substrate, the substrate can be held by a chuck of a recording/reproducing apparatus at the central opening at a correct position. Such a configuration can prevent contamination of the chuck or other components of the obtained magnetic recording medium that should have been caused by the resist remaining in the central opening. A magnetic recording medium with increased accuracy in reading magnetic data can be provided even in a magnetic recording medium with increased recording density and finer magnetic recording tracks, since the chuck correctly holds the magnetic recording medium.

In the double-sided coating method according to the invention, the coating solution is ejected independently to the first surface and the second surface of the substrate from the first and second coating solution nozzles and then the rinsing solution is ejected from the first and second rinsing solution nozzles. The substrate is then made to rotate. In this manner, the coating layers of uniform thickness can be formed on both surfaces of the substrate even if the coating layers have excessively thick portions due to ejection of the coating solution and rotation of the substrate. This is because the rinsing solution can be ejected to the thick portions of the coating layers and then the substrate is made to rotate so as to rinse off the thick portions of the coating layers on both the surfaces at the same time.

During formation of the coating layers, the rinsing solution may be ejected in an angled direction from an outer peripheral portion toward an inner peripheral portion of the rotating substrate so as to place the rinsing solution effectively at the thick portions of the coating layers. In this manner, the rinsing solution can be supplied only to the outer peripheral portion without reaching the inner peripheral portion of the substrate. With this configuration, when the coating solution of high viscosity is used to form the coating layers on the rotating substrate, thick portions of the coating layers that tend to be formed at the outer peripheral portion of the substrate can be rinsed off to provide the coating layers of uniform thickness.

### BRIEF DESCRIPTION OF THE DRAWINGS

FIG. 1 is a schematic diagram of an overall structure of a double-sided coating apparatus according to the invention seen from one side.

FIG. 2 is a schematic diagram of the overall structure of the double-sided coating apparatus according to the invention seen from another side.

FIG. 3A is a top view of a principal section of the double-sided coating apparatus according to the invention.

FIG. 3B is a schematic longitudinal cross-sectional view of the principal section of the double-sided coating apparatus according to the invention.

FIG. 4 is a top view of a cup housing opening and closing mechanism incorporated in the double-sided coating apparatus according to the invention.

FIG. 5 is a schematic longitudinal cross-sectional view of the cup housing opening and closing mechanism incorporated in the double-sided coating apparatus according to the invention.

FIG. 6 is a schematic diagram of a process sequence illustrating a step of chucking a substrate in the double-sided coating apparatus according to the invention.

FIG. 7 is a schematic diagram of a process sequence illustrating a step of moving nozzles to standby positions in the double-sided coating apparatus according to the invention.

FIG. 8 is a schematic diagram of a process sequence illustrating a step of moving a cup housing upward in the double-sided coating apparatus according to the invention.

FIG. 9 is a schematic diagram of a process sequence illustrating a step of moving a cover to a closed position in the double-sided coating apparatus according to the invention.

FIG. 10 is a schematic diagram of a process sequence illustrating a step of rotating the substrate at a low speed in the double-sided coating apparatus according to the invention.

FIG. 11 is a schematic diagram of a process sequence illustrating a step of applying a coating solution in the double-sided coating apparatus according to the invention.

FIG. 12 is a schematic diagram of a process sequence illustrating a step of spinning of the coating solution (i.e., rotating the substrate at a high speed) in the double-sided coating apparatus according to the invention.

FIG. 13 is a schematic diagram of a process sequence illustrating a step of applying a rinsing solution in the double-sided coating apparatus according to the invention.

FIG. 14 is a schematic diagram of a process sequence illustrating a step of spinning off the rinsing solution in the double-sided coating apparatus according to the invention.

FIG. 15 is a schematic diagram of a process sequence illustrating a step of stopping rotation of the substrate in the double-sided coating apparatus according to the invention.

FIG. 16 is a longitudinal cross-sectional view illustrating an exemplary discrete magnetic recording medium manufactured with the double-sided coating apparatus according to the invention.

FIG. 17 is a longitudinal cross-sectional view illustrating an exemplary substrate to which the coating solution is applied by the double-sided coating apparatus according to the invention.

FIG. 18 is a longitudinal cross-sectional view illustrating a state in which resist layers are formed by the double-sided coating apparatus according to the invention.

FIG. 19 is a longitudinal cross-sectional view illustrating resist patterns formed by patterning the resist layers.

### REFERENCE NUMERALS IN THE FIGURES

1: double-sided coating apparatus
2: substrate
2a: central opening
3: rotation driving mechanism
4: first solution coating unit
5: second coating solution supply unit
6: substrate housing section
7: housing
11: chuck (holding mechanism)
11a: receiving section
11b: nut section
12: rotation axis
16: first nozzle pivot arm
17: first pivot driving mechanism (moving mechanism for first coating solution nozzle)
18: first coating solution nozzle
19: first rinsing solution nozzle
23: first coating solution ejection port
24: first rinsing solution ejection port
26: second nozzle pivot arm
27: second rinsing solution nozzle
28: second coating solution nozzle
29: second coating solution ejection port
30: second rinsing solution ejection port
31: second pivot driving mechanism (moving mechanism for second coating solution nozzle)
34: cup housing
36: cup housing opening and closing mechanism
39: discharge port
40: air control member
40a: discharge pipe
43: cover

### BEST MODE FOR CARRYING OUT THE INVENTION

Next, a double-sided coating apparatus according to the invention will be described in detail with reference to drawings,

### <Configuration of Discrete Magnetic Recording Medium>

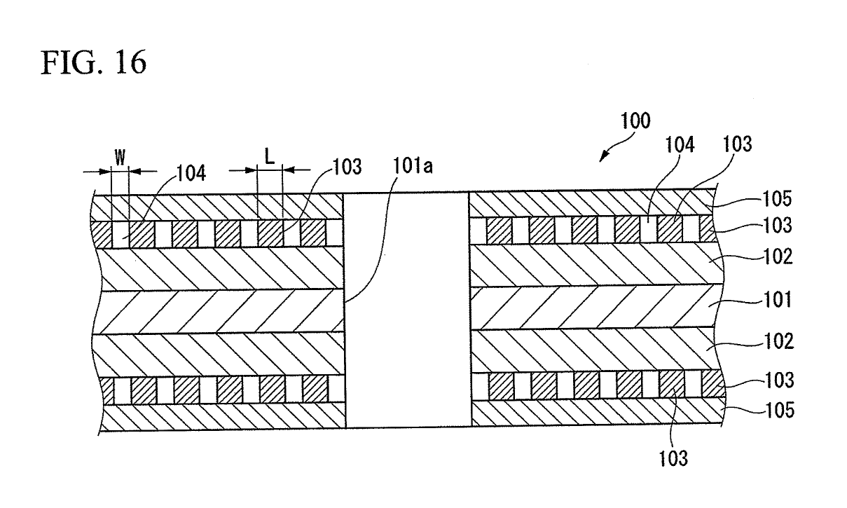

A discrete magnetic recording medium will be described as an exemplary substrate on which a coating layer is formed by a double-sided coating apparatus according to the invention. FIG. 16 illustrates a cross-sectional structure of the discrete magnetic recording medium.

A magnetic recording medium 100 includes a non-magnetic substrate 101 with a central opening 101a. On each of both main surfaces (i.e., upper and lower surfaces) of the non-magnetic substrate 101, an underlayer 102, a magnetic layer 103, a modifying section 104 and a protective film 105 are laminated. Each underlayer 102 consists of a soft magnetic layer, an intermediate layer and other layers. Each magnetic layer 103 has a magnetic pattern thereon. A lubricating film, which is not illustrated, is formed on each of outermost surfaces.

Note that the underlayer 102, the magnetic layer 103, the modifying section 104 and the protective film 105 are enlarged in thickness with respect to the non-magnetic substrate 101 in FIG. 16. In an actual lamination structure, the thickness of the non-magnetic substrate 101 is significantly larger than those of the layers and films illustrated. In FIG. 16, these layers and flims are enlarged in thickness for the ease of illustration.

In order to provide the magnetic recording medium 100 with increased recording density, the width W of a magnetic section of the magnetic layer 103 having a magnetic pattern formed thereon is preferably not more than 200 Inn and the width L of a non-magnetic section, i.e., a modifying section 104, is preferably not more than 100 nm. Accordingly, a track pitch P (P=W+L) is preferably as small as possible in a range of not more than 300 nm in order to increase recording density.

Any non-magnetic substrate can be employed as the non-magnetic substrate 101. Examples thereof include an Al alloy substrate, such as Al—Mg alloy, having Al as a principle component and substrates of normal soda glass, aluminosilicate-based glass, crystallized glass silicon, titanium, ceramic and various resin. Among these, an Al alloy substrate, a glass substrate, such as a crystallized glass substrate, and a silicon substrate are preferably used. Average surface roughness (Ra) of these substrates is preferably not more than 1 nm, more preferably not more than 0.5 mn and especially preferably not more than 0.1 nm.

The magnetic layer 103 formed on the non-magnetic substrate 101 may be an in-plane magnetic recording layer or a vertical magnetic recording layer. Among these, a vertical magnetic recording layer is especially preferred due to its high recording density. The magnetic recording layer is preferably made of Co-based alloy.

A magnetic recording layer for an in-plane magnetic recording medium may include an underlying layer of non-magnetic CrMo underlying layer and a magnetic layer of ferromagnetic CoCrPtTa magnetic layer laminated to each other.

Examples of the magnetic recording layer for a vertical magnetic recording medium include the following layers laminated to one another: a backing layer which includes soft magnetic FeCo alloy (e.g., FeCoB, FeCoSiB, FeCoZr, FeCoZrB and FeCoZrBCu), soft magnetic FeTa alloy (e.g., FeTaN and FeTaC) and soft magnetic Co alloy (e.g., CoTaZr, CoZrNB and CoB); an orientation controlling film which includes Pt, Pd, NiCr and NiFeCr; if necessary, an intermediate film which includes Ru; and a magnetic layer which includes 60Co-15Cr-15Pt alloy and 70Co-5Cr-15Pt-10SiO₂ alloy.

The thickness of the magnetic recording layer is, for example, not less than 3 nm to not more than 20 nm and is preferably not less than 5 nm to more than 15 nm. The thickness of the magnetic layer is selected so that sufficient input and output performance of the head is provided in accordance with the type and the lamination structure of the magnetic alloy used. The thickness of the magnetic layer 103 is selected appropriately so that certain output greater than predetermined output can be provided during reproduction. Usually, parameters representing the recording/reproducing property are impaired as the output increases.

In the present embodiment, magnetic property of a portion other than the magnetic layer 103, which corresponds to the magnetic recording track and the servo signal pattern section, is modified to provide a modifying section 104, which is a non-magnetic section. These magnetic recording patterns are magnetically separated by the modifying section 104. In this manner, signal interference between the magnetic recording patterns of adjacent magnetic layers 103 is prevented.

In particular, modification of the magnetic property of the magnetic layer 103 includes partially changing coercive force, residual magnetization and other parameters of the magnetic layer formed as a uniform film on a substrate. For example, both the coercive force and the residual magnetization are decreased. Magnetic property can be modified by, for example, exposing a portion Other than the magnetic recording patterns of the magnetic layer formed uniformly on the non-magnetic substrate to reactive plasma, which will be described later. A portion exposed to reactive plasma becomes the modifying section 104.

Note that the double-sided coating apparatus according to the invention can be applied to a substrate for a discrete track medium obtained through an exemplary modification process, in which the magnetic recording pattern and a modified section are physically separated by forming an uneven surface using a stamper or other device and partially patterning the magnetic film. Thus, the magnetic recording medium 100 described above is employed as a substrate to which the double-sided coating apparatus according to the invention may be applied.

Alternatively, the protective film layer 105 may be a carbonaceous layer including carbon (C), hydrogenated carbon (HxC), carbon nitride (CN), amorphous carbon or silicon carbide (SiC), or other usually employed protective layer materials, such as SiO₂, Zr₂O₃ and TiN. The protective layer 105 may include two or more layers.

The thickness of the protective layer 105 should be less than 10 nm. If the protective film 105 is thicker than 10 nm, distance between the head and the magnetic layer 103 is excessively large and thus intensity of the input and output signals becomes insufficient.

Preferably, a lubricating layer is formed on the protective film 105. Examples of the lubricant include a fluorine-based lubricant, a hydrocarbon-based lubricant and mixtures thereof. The lubricant is usually applied to the thickness of 1 to 4 nm to provide a lubricating film.

In the magnetic recording medium 100 as an example, magnetic property of the portion other than the magnetic recording patterns on the magnetic layer 103 is modified to provide the modifying section 104. The magnetic recording pattern is magnetically separated in a reliable manner. There is no signal interference between adjacent patterns. Thus, significantly high recording density property can be obtained. Since no uneven configuration is provided on the substrate in the magnetic recording medium 100, a highly smooth surface and a low levitation magnetic head can be obtained.

### <Configuration of Double-Sided Coating Apparatus>

Next, an embodiment of a double-sided coating apparatus according to the invention will be described.

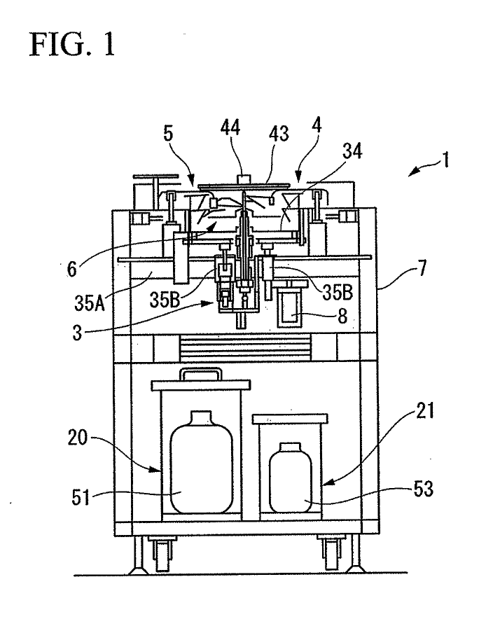

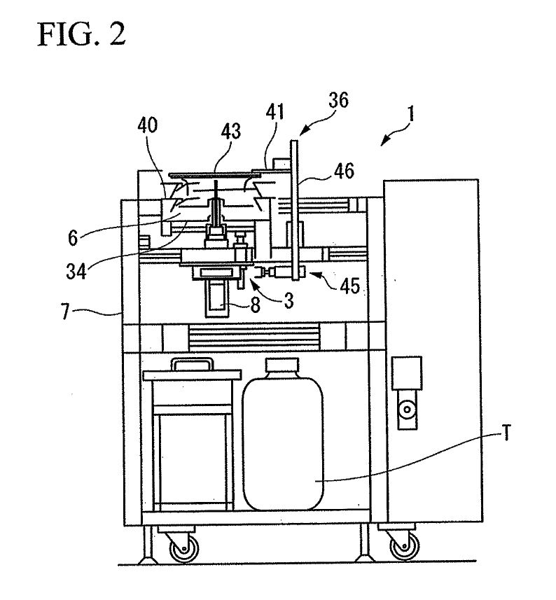

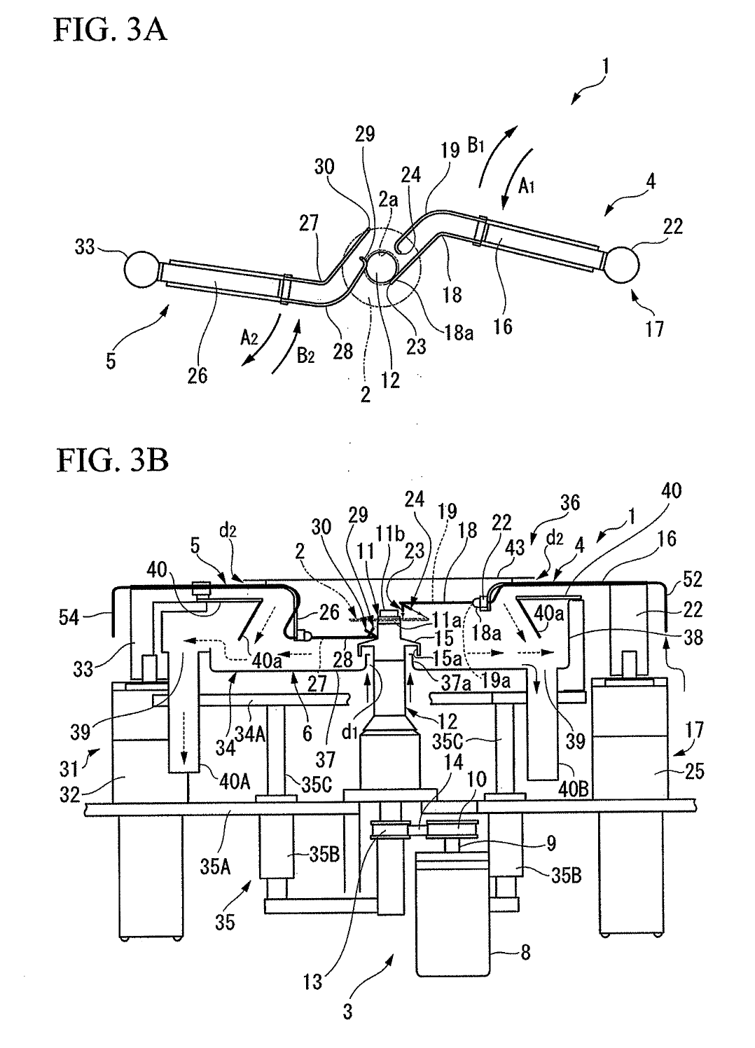

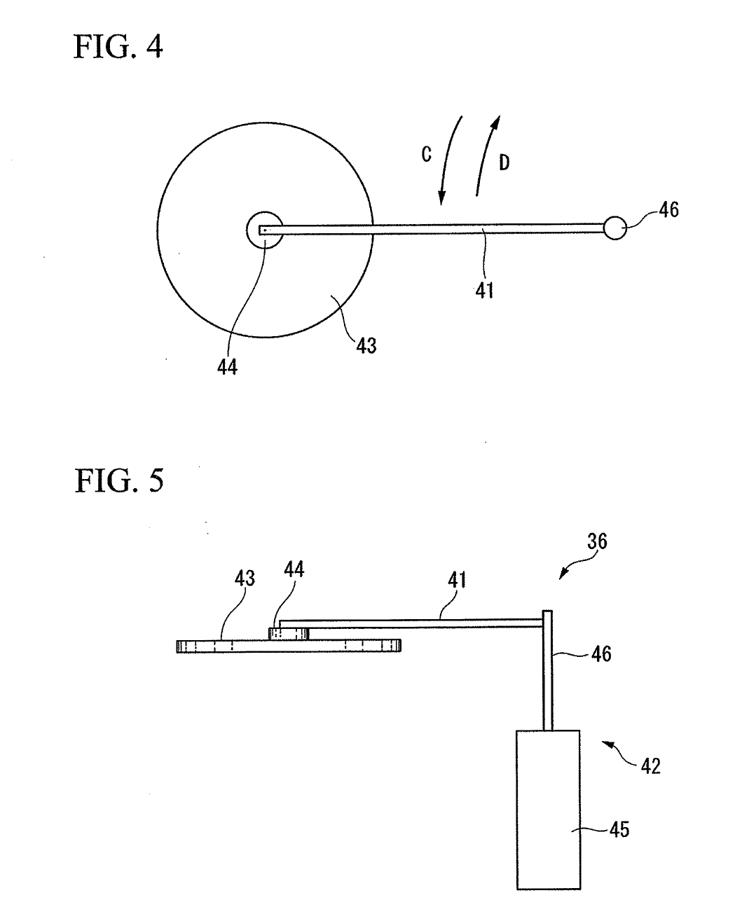

FIG. 1 is a fragmentary cross-sectional view of an overall structure of a coating apparatus according to the invention seen from. one direction. FIG. 2 is a fragmentary cross-sectional view of an overall structure of the coating apparatus seen from another direction. FIG. 3A is a top view of a principal section of the coating apparatus. FIG. 3B is a schematic longitudinal cross-sectional view of the principal section of the coating apparatus. FIG. 4 is a top view of a cup housing opening and closing mechanism incorporated in the coating apparatus. FIG. 5 is a schematic longitudinal cross-sectional view of a cup housing opening and closing mechanism incorporated in the coating apparatus.

As illustrated in FIGS. 1 to 3, a double-sided coating apparatus 1 according to the invention includes a rotation driving mechanism 3, a first solution coating unit 4, a second solution coating unit 5 and a substrate housing section 6. The rotation driving mechanism 3 holds and drives a toroidal disc-shaped substrate 2 to rotate. The first solution coating unit 4 supplies a liquid material onto a first surface of the substrate 2. The second solution coating unit 5 supplies. a coating solution onto a second surface of the substrate 2. The substrate housing section 6 houses the substrate 2 held on the rotation driving mechanism 3. These components are accommodated in a housing 7. The housing 7 is made of a metallic material and forms an outer wall of a main body of the apparatus.

As illustrated in an expanded view in FIG. 3, the rotation driving mechanism 3 includes a spindle motor 8, a pulley 10, a rotation axis 12 and a pulley 13. The pulley 10 is attached at an end of a spindle shaft 9 which is a driving shaft of the spindle motor 8. The rotation axis 12 includes a chuck (i.e., a holding mechanism) 11 which holds the substrate 2. The pulley 13 is attached to a lower end of the rotation axis 12. The pulley 10 and the pulley 13 are moved cooperatively via a belt 14.

The chuck (i.e., a holding mechanism) 11 for the substrate 1 is provided at and integrally with an upper end of the rotation axis 12. A central opening 2a of the horizontally-kept substrate 2 can be fit onto and fixed to the chuck 11. The chuck 11 includes a receiving section Ila and a nut section 11b. The receiving section 11a is provided at a top end of the rotation axis 12. The central opening 2a of the substrate 2 is fit into the receiving section 11a. The nut section 11b is screwed into a screwed shaft formed at an upper end of the receiving section 11a. The chuck 11 is configured so that the central opening 2a of the substrate 2 is fit into the receiving section 11a and the nut section 11b is screwed thereinto. In this manner, the substrate 2 is fixed horizontally and the substrate 2 can be rotated integrally with the rotation axis 12. The central opening 2a of the substrate 2 is closed by the receiving section 11a when mounted on the receiving section 11a of the chuck 11.

An umbrella-shaped air control section 15 for controlling an air flow, which will be described later, is provided on the rotation axis 12 under the chuck 11 of the rotation axis 12. The air control section 15 is provided to project along an outer peripheral surface of the rotation axis 12 and is formed as an umbrella with a pocket 15a formed therebelow.

In the thus-configured rotation driving mechanism 3, when the spindle motor 8 is driven. and the pulley 10 rotates, the rotation is transmitted to the pulley 13 via the belt 14 and the rotation axis 12 is driven to rotate in the horizontal direction. When the rotation axis 12 is driven to rotate, the substrate held on the rotation axis 12 is rotated in the horizontal direction in accordance with the rotational direction and the rotational speed of the spindle motor 8.

The first solution coating unit 4 includes a first nozzle pivot arm 16, a first pivot driving mechanism (i.e., a moving mechanism for the first coating solution nozzle) 17, a first coating solution nozzle 18 and a first rinsing solution nozzle 19, a first coating solution supply unit 20 and a first rinsing solution supply unit 21. The first nozzle pivot arm 16 is pivotable in the directions of arrow A₁ and arrow B₁ in FIG. 3A. The first pivot driving mechanism 17 drives the first nozzle pivot arm 16 to pivot. The first coating solution nozzle 18 and the first rinsing solution nozzle 19 are attached to both ends of the first nozzle pivot arm 16. The first coating solution supply unit 20 (see FIG. 1) supplies a coating solution to the first coating solution nozzle 18. The first rinsing solution supply unit 21 (see FIG. 1) supplies a rinsing solution to the first rinsing solution nozzle 19.

The first nozzle pivot arm 16 is formed in a band plate shape and has the first coating solution nozzle 18 and the first rinsing solution nozzle 19 disposed at both ends thereof. As illustrated in detail in FIG. 3B, a distal end of the first nozzle pivot arm 16 is bent downward and a nozzle junction which supports the first coating solution nozzle 18 and the first rinsing solution nozzle 19 is provided at the distal end. A coating solution ejected from a first coating solution supply unit 20, which will be described later, is supplied to the nozzle 18. A rinsing solution ejected from a first rinsing solution supply unit 21, which will be described later, is supplied to the nozzle 19.

The distal ends of the first coating solution nozzle 18 and the first rinsing solution nozzle 19 are attached to the first nozzle pivot arm 16 so that their height is slightly larger than that of an upper surface of the substrate which is held horizontally by the chuck 11. The first coating solution nozzle 18 and the first rinsing solution nozzle 19 are formed as pipes.

As illustrated in FIG. 3A, the first coating solution nozzle 18 is bent obtusely along a horizontal direction at a position slightly projected from the first nozzle pivot arm 16 when seen in a plan view. A distal end 18a of the first coating solution nozzle 18 extends so as to be in contact with a peripheral edge of a round central opening 2a of the substrate 2 at one pivoted position of the first coating solution nozzle 18 illustrated in FIG. 3A. A distal end of the first coating solution nozzle 18 is further bent downward at substantially 90 degrees as illustrated in FIG. 3B. The distal end opening of the first coating solution nozzle 18 is formed to constitute a first coating solution ejection port 23 through which the coating solution is ejected downward to an upper surface of the substrate 2. The first coating solution ejection port 23 faces an upper surface of the substrate 2 at a predetermined distance when the first coating solution ejection port 23 is positioned right above the upper surface of the substrate 2.

As illustrated in FIG. 3A, the first rinsing solution nozzle 19 is also mounted on the first nozzle pivot arm 16 in the same manner as the first coating solution nozzle 18. The first rinsing solution nozzle 19 is bent obtusely along a horizontal direction at a position slightly projected from the first nozzle pivot arm 16. The first rinsing solution nozzle 19 extends in the same direction and in substantially parallel with the first coating solution nozzle 18. A distal end of the first rinsing solution nozzle 19 is positioned at a radially central position of the upper surface of the substrate 2 when the distal end 18a of the first coating solution nozzle 18 as illustrated FIG. 3A is positioned in contact with the peripheral edge of the round central opening 2a of the substrate 2. The first rinsing solution nozzle 19 is bent so that an end opening 24 thereof faces an outer peripheral edge of the substrate 2 and the first coating solution nozzle 18. The end opening 24 of the first rinsing solution nozzle 19 is formed as a first rinsing solution ejection port 24 through which a rinsing solution is ejected toward an outer peripheral edge of the first main surface (i.e., an upper surface) of the substrate 2.

The first pivot driving mechanism 17 includes a first driving motor 25 and a first pivot shaft 22. The first pivot shaft 22 is attached at an end of a driving shaft of the first driving motor 25. Abase end of the first nozzle pivot arm 16 is attached to an upper end of the first pivot shaft 22. The first nozzle pivot arm 16 pivots along a horizontal surface so that the first coating solution nozzle 18 and the first rinsing solution nozzle 19 move close to or away from the substrate 2 while pivoting horizontally. In particular, when the first driving motor 25 is driven and the first pivot shaft 22 is driven to pivot, the first nozzle pivot arm 16 is operated to pivot in the direction of arrow A₁ or B₁ in FIG. 3(1) in accordance with the rotational direction of the first driving motor 25.

Length and a bending position of the first nozzle pivot arm 16 and length of the pivot shaft 22 are determined so that the distance between the first coating solution ejection port 23 and the upper surface of the substrate 2 and the distance between the first rinsing solution ejection port 24 and the upper surface of the substrate 2 are in appropriate ranges.

The first coating solution supply unit 20 includes a pressure tank 51 for the coating solution, a first coating solution supply pipe 52 and a valve for the first coating solution which is not illustrated. A coating solution is stored in the pressure tank 51. A first end of the first coating solution supply pipe 52 is connected to a base end of the first coating solution nozzle 18 and a second end is connected to the pressure tank 51. The valve for the first coating solution is disposed between the coaling solution supply pipe 52 and the pressure tank 51. Opening and closing of the valve is controlled by a control section, which is not illustrated. An ejection amount and ejection time of the coating solution from the first coating solution ejection port 23 are controlled by opening and closing of the valve for the first coating solution.

Examples of the coating solution include solutions in which various resists, such as thermosetting resin, UV curing resin and SOG are dissolved in solvents. Viscosity of the coating solution is preferably 0.5 to 1 cP.

A rinsing solution supply unit 21 includes a pressure tank 53 for the rinsing solution, a first rinsing solution supply pipe 54 and a valve for the first rinsing solution, which is not illustrated. A rinsing solution is stored in the pressure tank 53. A first end of the first rinsing solution supply pipe 54 is connected to a base end. of the first rinsing solution nozzle 19 and a second end is connected to the pressure tank 53. The valve for the first rinsing solution is disposed between the first rinsing solution supply pipe 54 and the pressure tank 53. The valve for the first rinsing solution is controlled by a control section, which is not illustrated. An ejection amount and ejection time of the rinsing solution from the first rinsing solution ejection port 24 are controlled by opening and closing of the valve for the first rinsing solution.

When supplied to a coating layer, the rinsing solution partially dissolves and removes the coating layer and controls the thickness of the coating layer to be uniform.

Examples of the rinsing solution include solutions which dissolve the coating solution and have low reactivity with the coating solution.

In the thus-configured first solution coating unit 4, when the first driving motor 25 is driven, the first nozzle pivot arm 16 is driven to pivot in the direction of arrow A₁ or arrow B₁ in FIG. 3A in accordance with the rotational direction of the first driving motor 25. Then, the first coating solution ejection port 23 of the first coating solution nozzle 18 and the first rinsing solution ejection port 24 of the first rinsing solution nozzle 19 pivot horizontally about the pivot shaft 22 so as to move close to or away from the substrate 2.

In the configuration described above, the first coating solution ejection port 23 moves among the following positions: a first (i.e., initial) position separated from a cup housing 34 described later; a second (i.e., standby) position near the outer peripheral edge of the substrate 2; a third (i.e., coating start) position right above an inner periphery edge of the upper surface of the substrate 2; and a fourth (i.e., coating end) position right above an outer peripheral edge of the upper surface of the substrate 2. The first rinsing solution ejection port 24 is moved to follow the first coating solution ejection port 23.

When the coating solution is supplied to the first coating solution nozzle 18 with the first coating solution ejection port 23 being positioned above the upper surface of the substrate 2, the coating solution is ejected downward from the first coating solution ejection port 23 and is supplied to the upper surface of the substrate 2.

When the rinsing solution is supplied to the first rinsing solution nozzle 19 with the first rinsing solution ejection port 24 being positioned above the upper surface of the substrate 2 as illustrated in FIGS. 3A and 3B, the rinsing solution is ejected from the first rinsing solution ejection port 24 toward an outer peripheral edge of the substrate 2 and is supplied to the upper surface outer peripheral edge of the substrate 2.

A second nozzle pivot arm 26, a second coating solution nozzle 28 and a second rinsing solution nozzle 27 of the second solution coating unit 5 are structured in the same manner as those of the first nozzle pivot arm 16, the first coating solution nozzle 18 and the first rinsing solution nozzle 19, respectively. Thus, the second solution coating unit 5 has the same configuration as that of the first solution coating unit 4.

In particular, in the second solution coating unit 5, the second nozzle pivot arra 26 is formed in a band plate shape as in the first nozzle pivot arm 16. As illustrated in FIG. 3B, the second nozzle pivot arm 26 is bent largely downward and has a nozzle junction at a distal end thereof at which the second coating solution nozzle 28 and the second rinsing solution nozzle 27 are supported. The nozzles 27 and 28 attached to the second nozzle pivot arm 26 extend slightly downward from the lower surface of the substrate 2.

The second coating solution nozzle 28 and the second rinsing solution nozzle 27 are bent to be symmetric with the first coating solution nozzle 18 and the first rinsing solution nozzle 19 in the first solution coating unit 4.

An end opening of the second coating solution nozzle 28 of the present embodiment is formed as the second coating solution ejection port 29 through which the coating solution is ejected toward the second main surface of the substrate 2. When the second coating solution ejection port 29 is below the lower surface of the substrate 2, the second coating solution ejection port 29 faces the lower surface of the substrate 2 at a predetermined distance. An end opening of the second rinsing solution nozzle 27 is formed as a second rinsing solution ejection port 30 through which the rinsing solution is ejected toward the lower surface outer peripheral edge of the substrate 2. When the second rinsing solution ejection port 30 is below the inner periphery edge of second main surface of the substrate, the second rinsing solution ejection port 30 faces the outer peripheral edge of the second main surface of the substrate 2 at a predetermined distance.

In the second solution coating unit 5, the second pivot driving mechanism drives the second nozzle pivot arm 26 to rotate. The second coating solution supply unit supplies the coating solution to the second coating solution nozzle 28. The second rinsing solution supply unit supplies the rinsing solution to the second rinsing solution supply unit 28.

In the thus-configured second solution coating unit 5, when the second driving motor 32 is driven, the second nozzle pivot arm 26 is operated to pivot in the direction of arrow A₂ or arrow B₂ in FIG. 3A in accordance with the driving direction of the second driving motor 32. Then, the second coating solution ejection port 29 of the second coating solution nozzle 28 and the second rinsing solution ejection port 30 of the second rinsing solution nozzle 27 move in a circular direction about the pivot shaft 33.

In the configuration. described above, the second coating solution ejection port 29 moves among the following positions: a secondary first (i.e., initial) position separated from the cup housing 34, which will be described later; a secondary second (i.e., standby) position near the outer peripheral edge of the substrate 2; a secondary third (i.e., coating start) position below the inner periphery edge of the lower surface of the substrate 2; and a secondary fourth (i.e., coating end) position below the outer peripheral edge of the second main surface of the substrate 2. The second rinsing solution ejection port 30 is moved to follow the second coating solution ejection port 29.

When the coating solution is supplied to the second coating solution nozzle 28 with the second coating solution ejection port 29 positioned below the lower surface of the substrate 2, the coating solution is ejected from the second coating solution ejection port 29 and is supplied to the lower surface of the substrate 2.

When the rinsing solution is supplied to the second rinsing solution nozzle 27 with the second rinsing solution ejection port 30 positioned below the inner periphery edge of the lower surface of substrate 2, the rinsing solution is ejected from the second rinsing solution ejection port 30 and is supplied to the outer peripheral edge of the lower surface of the substrate 2.

The substrate housing section 6 includes a cup housing 34, a cup housing movement mechanism 35 and a cup housing opening and closing mechanism 36. The cup housing 34 houses the substrate 2 held by the rotation driving mechanism 3 during application of the coating solution. The cup housing movement mechanism 35 moves the cup housing 34 upward and downward. The cup housing opening and closing mechanism 36 opens and closes an opened end of the cup housing 34.

The cup housing 34 includes a toroidal disc-shaped bottom 37 and a side wall section 38. The side wall section 38 is provided along an outer peripheral edge of the bottom 37.

The rotation axis 12 of the rotation driving mechanism 3 is inserted in a central opening of the bottom 37. The chuck 11 and the air control section 15 of the rotation driving mechanism 3 are located above the bottom 37. An inner periphery edge 37a of the bottom 37 is bent upward to provide a clearance dl between the bottom 37 and the rotation axis 12. When the cup housing 34 is in its housing position, which will be described later, an upper end of the inner periphery edge 37a of the bottom 37 is housed in the pocket 15a of the umbrella-shaped air control section 15 provided in the rotation axis 12.

An outer peripheral of the bottom 37 has a discharge port 39 divided by a discharge pipe 40A. A discharge pump is connected to the discharge port 39 via the discharge pipe 40A. When the discharge pump is in its operating state, air supplied to the cup housing 34 is discharged from the discharge port 39 to outside via the discharge pipe.

An air control member 40 is attached to an upper end of the side wall section 38 to control a flow of air supplied to the cup housing.

The air control member 40 is formed in a toroidal disc shape when seen in a plan view. An outer peripheral edge of the air control member 40 is attached to an upper end of the side wall section 38. An opening of an inner peripheral side of the air control member 40 constitutes an opening through which the substrate 2 and the nozzles 18, 19, 27 and 28 are placed in or removed from the cup housing 34. The air control member 40 has a slope surface 40a descending downward toward the outer peripheral side from an inner peripheral end. Air supplied to the cup housing 34 through the opening on the air flow, which will be described later, is fed to the outer peripheral side along the slope surface 40a and reaches the discharge port 39. A discharge pipe 4013 is formed in an inside corner of the cup housing 34. The discharge pipe 40B is connected to a collection tank T accommodated in the housing 7 of the double-sided coating apparatus so as to the collect a processed coating solution.

The cup housing movement mechanism 35 moves the cup housing 34 upward and downward along the axis direction of the rotation shaft 12, Accordingly, the cup housing 34 is moved between a non-housing position below the substrate 2 and a housing position at which the substrate 2 is housed in the cup housing 34.

In the cup housing movement mechanism 35, piston devices 35B and 35B are attached to a frame 3 5A provided horizontally inside the housing 7 surrounding the entire device. Piston rods 35C are provided in each of the piston devices 35B to be movable upward and downward. A base frame 34A of the cup housing 34 is supported by the piston rod 35C so that the cup housing 34 is supported to be movable upward and downward.

As illustrated in FIGS. 4 and 5, the cup housing opening and closing mechanism 36 includes a pivot arm 41, a pivot driving mechanism 42 and a cover 43. The pivot arm 41 is provided to pivot in the directions of arrow C and arrow D in FIG. 4. The pivot driving mec anism 42 drives the pivot arm 41 to pivot. The cover 43 is attached at a distal end of the pivot arm 41.

The cover 43 is formed as a disc whose diameter is lager than that of the opening of the cup housing 34. A pivot arm mounting section 44 is provided at the center of an upper surface of the cover 43, A distal end of the pivot arm 41 is attached to the pivot arm mounting section 44. That is, the cover 43 is attached to the distal end of the pivot arm 41 via the pivot arm mounting section 44. The pivot driving mechanism 42 includes a pivot motor 45 and a pivot shaft 46. The pivot shaft 46 is attached to a distal end of the driving shaft of the pivot motor 45 coaxially with the driving shaft. The pivot arm 44 is fixed to the pivot shaft 46 perpendicularly to an axial direction of the pivot shaft 46.

Length of the pivot shaft 46 and the fixing position of the pivot arm 41 are determined such that the cover 43 is disposed at a position slightly above the air control member 40 where the cover 43 does not interfere with the first and second pivot arms 16 and 26 with the cover 43 being in its closed position, which will be described later.

In the thus-configured cup housing opening and closing mechanism 36, when the pivot motor 45 is driven, the pivot shaft 46 is driven to rotate and the pivot arm 41 is operated to pivot in the direction of arrow C or arrow D in FIG. 4 in accordance with the rotational direction of the pivot motor 45. When the pivot arm 41 is operated to pivot in this manner, the cover 43 is moved in the horizontal direction about the pivot shaft 46 and between an open position away from the cup housing 34 and a closed position at which the opening of the cup housing 34 is closed.

In the thus-configured substrate housing section 6, when the cover 43 is in its closed position, air is discharged from the discharge port 39 to be supplied through a clearance d2 between the cover 43 and the air control member 40 and through the clearance d1 between the rotation axis 12 and the bottom 37 of the cup housing 34. Air supplied through the clearance d2 between the cover 43 and the air control member 40 is fed toward an outer peripheral side along the slope surface 4a of the air control member 40 and is discharged from the discharge port 39. Air supplied from the clearance dl between the rotation axis 12 and the bottom 37 of the cup housing 34 is fed toward an outer peripheral side along the bottom 37 through the pocket 15a below the umbrella-shaped air control section 15 and is discharged from the discharge port 39. With such an air flow generated inside the cup housing 34, the coating solution applied to the substrate 2 is dried efficiently. Although not particularly limited, examples of the air include a flow of air, such as micro dust-free clean air, or inactive gas-mixed gas such as nitrogen.

The thus-configured coating apparatus 1 includes an operating section and a control section. The operating section inputs various pieces of information. The control section controls operations of components.

Examples of the operating section include a keyboard and a touch panel.

The control section includes a computer incorporating a computation section and memory storage. Signals (i.e., input) from the operating section are input to the control section. The control section controls operations of components in accordance with a program previously set on the basis of the signals. In particular, in the coating apparatus of the present embodiment, the control section preferably has a device to individually control, during application of the coating solution to both the main surfaces of the substrate 2, the ejection amount of the coating solution from the first coating solution ejection port 23, the scan speed of the first coating solution ejection port 23, the ejection amount of the coating solution from the second coating solution ejection port 29 and the scan speed of the second coating solution ejection port 29 such that the coating layers formed on both the main surfaces of the substrate 2 have substantially the same thickness.

The control section also preferably has a device to individually control, during application of the rinsing solution to the outer peripheral edge of the coating layer, the ejection amount of the rinsing solution from the first rinsing solution ejection port 24, the scan speed of the first rinsing solution ejection port 24, the ejection amount of the rinsing solution from the second rinsing solution ejection port 30 and the scan speed of the second rinsing solution ejection port 30 such that the supplying amount of the rinsing solution are substantially the same in both the main surfaces of the substrate 2.

### <Manufacturing Discrete Magnetic Recording Medium>

Next, a step of applying the coating solution with the coating apparatus 1 will be described. The step is incorporated in a manufacturing process of a discrete magnetic recording medium illustrated in FIG. 16.

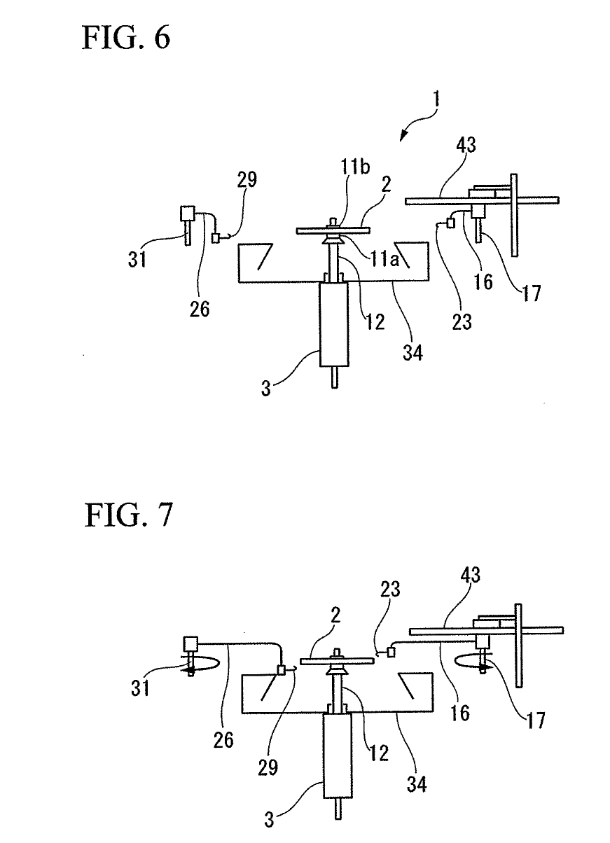

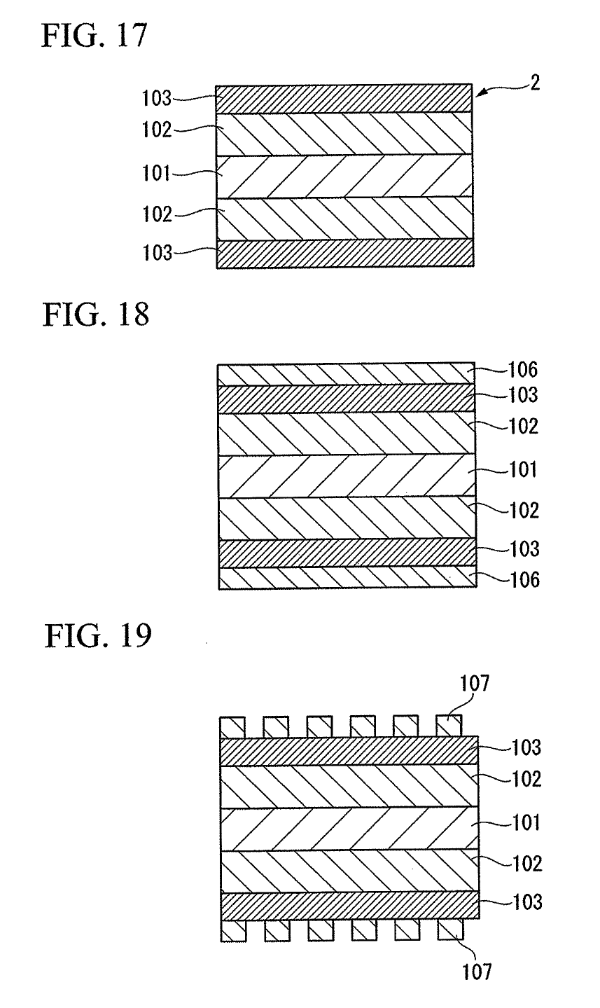

FIGS. 6 to 15 are schematic diagrams illustrating a process sequence of the coating apparatus in a process order. FIG. 16 is a longitudinal cross-sectional view of an exemplary substrate. FIG. 17 is a longitudinal cross-sectional view illustrating a state in which the underlayer 102 and the magnetic layer 103 are formed on the non-magnetic substrate 101. FIG. 18 is a longitudinal cross-sectional view illustrating a state in which the resist layer is formed by the coating apparatus according to the invention. FIG. 19 is a longitudinal cross-sectional view of a resist pattern formed by patterning the resist layer.

First, the underlayer 102 consisting of a soft magnetic layer, an intermediate layer and other layers is formed in a normal process on each of the main surfaces of the non-magnetic substrate 101 having a central opening. The magnetic layer 103 is then formed on each of the underlayers 102. The magnetic layer 103 is formed as a thin film on the entire upper surface of the underlayer 102 by sputtering or other processes. FIG. 17 illustrates a cross-sectional structure of the non-magnetic substrate 101 with various films formed thereon.

A resist layer is formed on the entire surface of the magnetic layer 103. The resist layer is patterned in a plane configuration in accordance with a magnetic recording pattern to provide a resist pattern.

The resist layer is formed in the following manner with the double-sided coating apparatus 1 that has the configuration described above. The non-magnetic substrate 101 with the magnetic layer 103 formed thereon is used as the substrate 2.

As illustrated in FIG. 6, in an initial state of the double-sided coating apparatus 1, the nozzles 18 and 28 for the coating solution are in their first positions, the nozzles 19 and 27 for the rinsing solution are in their secondary first positions, the cup housing 34 is in its non-housing position and the cover 43 is in its open position.

The central opening 2a of the substrate 2 is mounted on the receiving section 11a of the chuck 11 and the but section 11b is screwed into the receiving section 11a. In this manner, the substrate 2 is kept horizontally on the rotation axis 12.

Next, components are turned on.

As illustrated in FIG. 7, the first pivot driving mechanism 17 drives the first nozzle pivot arm 16 to pivot in the direction of arrow A₁ in FIG. 3A so that the first coating solution ejection port 23 is moved to the second (i.e., standby) position from the first (i.e., initial) position. Similarly, the second pivot driving mechanism 31 drives the second nozzle pivot arm 26 to pivot in the direction of arrow A₂ in FIG. 3A so that the second coating solution ejection port 29 is moved to the secondary second (i.e., standby) position from the first (i.e., initial) position. The first rinsing solution ejection port 24 is moved to follow the first coating solution ejection port 23 and the second rinsing solution ejection port 30 is moved to follow the second coating solution ejection port 29.

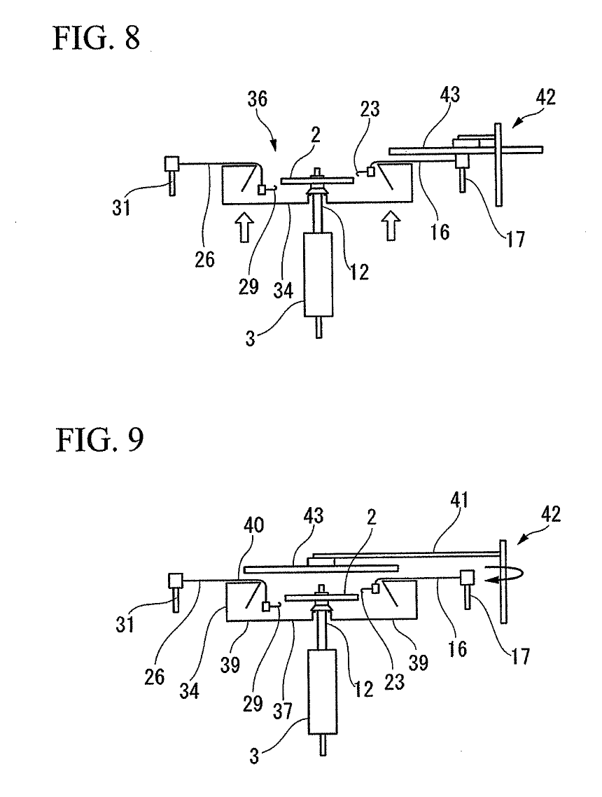

Next, as illustrated in FIG. 8, the cup housing opening and closing mechanism 36 moves the cup housing 34 to the housing position from the non-housing position. Thus, the substrate 2 held on the rotation axis 12 is housed in the cup housing 34.

Next, as illustrated in FIG. 9, the pivot driving mechanism 42 drives the pivot arm 41 to pivot in the direction of arrow C in FIG. 9 so that the cover 43 is moved to the closed position from the open position. Air is sucked out of the discharge port 39 and supplied through the clearance d2 between the cover 43 and the air control member 40 and through the clearance d1 between the bottom 37 of the cup housing 34 and the rotation axis 12. The supplied air is made to flow through the cup housing 34 and is discharged from the discharge port 39. Air flows uniformly since a space to which air is supplied (i.e., a space in which the substrate 2 is disposed) is surrounded by the cup housing 34 and the cover 43.

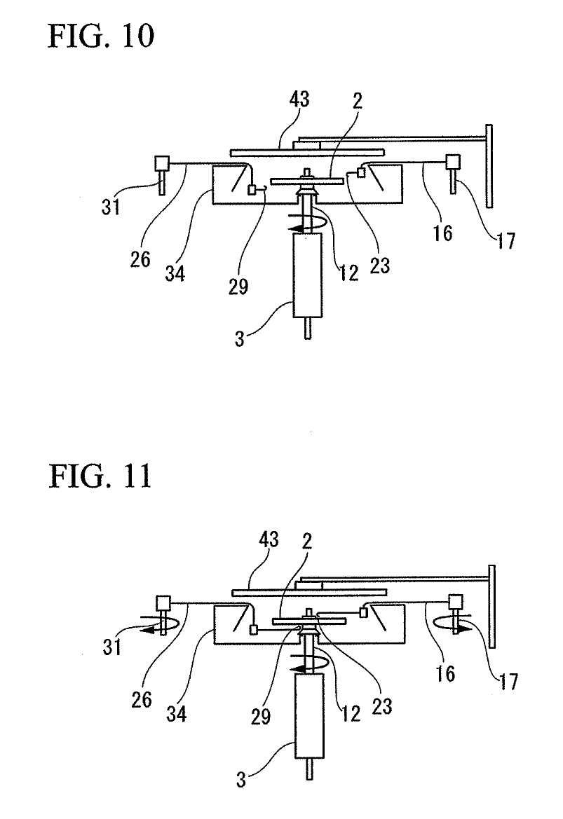

Next, as illustrated in FIG. 10, the rotation driving mechanism 3 drives the rotation axis 12 to rotate at a predetermined rotational speed. The substrate 2 is thus rotated in accordance with the rotational direction and the rotational speed of the rotation axis 12.

Next, as illustrated in FIG. 11, the first pivot driving mechanism 17 drives the first nozzle pivot arra 16 to pivot in the direction of arrow A₁ in FIG. 3A so that the ejection port 23 for the first coating solution is moved to the third (i.e., coating start) position from the second (i.e., standby) position. Similarly, the second pivot driving mechanism 31 drives the second nozzle pivot atm 26 to pivot in the direction of arrow A₂ in. FIG. 3A so that the ejection port 23 for the first coating solution is moved to the third (i.e., coating start) position from the second (i.e., standby) position. The first rinsing solution ejection port 24 is moved to follow the rust coating solution ejection port 23 and the second rinsing solution ejection port 30 is moved to follow the second coating solution ejection port 29.

Next, the coating solution supply unit 20 supplies the coating solution to the first and second coating solution nozzles 18 and 28 so that a predetermined amount of the coating solution is ejected from the first and second coating solution ejection ports 23 and 29.

In this manner, the first coating solution ejection port 23 can apply the coating solution to the upper surface of the substrate 2 while scanning across the upper surface of the substrate 2 from the inner peripheral edge to the outer peripheral edge. Simultaneously, the second coating solution ejection port 30 can apply the coating solution to the lower surface of the substrate 2 while scanning across the lower surface of the substrate 2 from below. Thus, the coating solution can be applied to both the upper and lower surfaces of the substrate 2 at the same time.

The control section independently controls the ejection amount of the coating solution and the scan speed of the first coating solution ejection port 23, the ejection amount of the coating solution and the ejection amount of the coating solution in the second coating solution ejection port 29.

The first coating solution ejection port 23 ejects the coating solution downward and the second coating solution ejection port 29 ejects the coating solution upward. Accordingly, the coating solution ejected from the ejection port 23 and the coating solution ejected from the ejection port 29 behave differently. Under the same condition for applying the coating solution (e.g., the ejection amount and the scan speed of the coating solution ejection port), the coating layer formed on the upper surface (i.e., the first main surface) and the coating layer formed on the lower surface (i.e., the second main surface) have different thickness.

In the coating apparatus 1, however, since the ejection amount of the coating solution and the scan speed of the first coating solution ejection port 23 and the ejection amount of the coating solution and the scan speed of the second coating solution ejection port 29 are controlled independently, these parameters can be independently determined so that targeted film thickness can be obtained on both the upper and lower surfaces of the substrate 2. Accordingly, the coating solution can be applied to both the main surfaces of the substrate 2 at the same time in the targeted supply amount.

Ingression of the coating solution into the central opening 2a can be prevented with a configuration described below: the central opening 2a of the substrate 2 is closed by the receiving section 11a of the chuck 11; the coating solution is moved toward the outer peripheral direction due to rotation of the substrate 2; and the coating solution is ejected from the ejection ports 23 and 30 to outside of the peripheral edge position of the central opening 2a of the substrate 2.

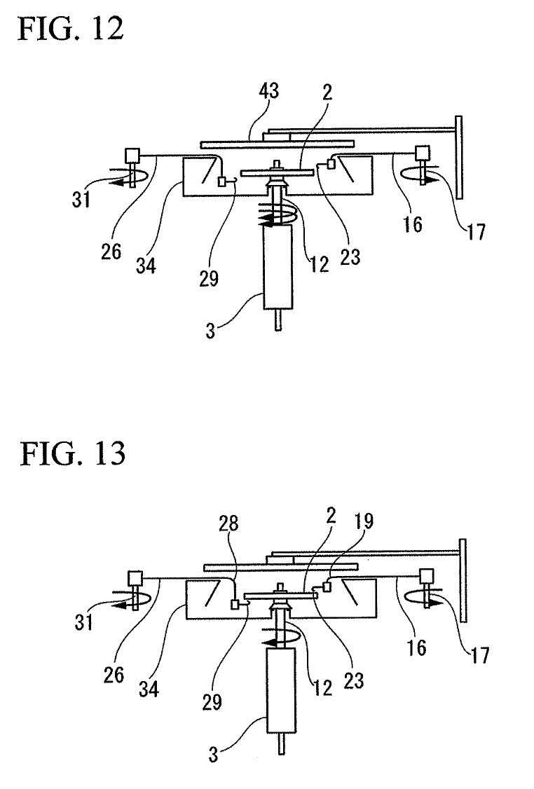

Next, as illustrated in FIG. 12, the first pivot driving mechanism 17 drives the first nozzle pivot arm 16 to pivot in the direction of arrow B₁ in FIG. 3A so that the first coating solution ejection port 23 is moved to the second (i.e., standby) position from the fourth (i.e., coating end) position. The second pivot driving mechanism 31 drives the second nozzle pivot arm 26 to pivot in the direction of arrow B₂ in FIG. 3A so that the second coating solution ejection port 29 is moved to the secondary second (i.e., standby) position from the secondary fourth (i.e., coating end) position. The first rinsing solution ejection port 24 is moved to follow the first coating solution ejection port 23 and the second rinsing solution ejection port 30 is moved to follow the second coating solution ejection port 29.

The rotation driving mechanism 3 controls the rotational speed of the rotation axis 12 to a predetermined rotational speed. The substrate 2 can thus be rotated in accordance with the rotational speed so that the coating solution spreads out on the upper and lower surfaces of the substrate 1. The rotation driving mechanism 3 stops rotation of the substrate 2 after a predetermined time has elapsed.

When the substrate 2 is rotated at a high speed, the coating solution applied to both the main surfaces of the substrate 2 spreads out toward the outer peripheral end due to centrifugal force to form layers of uniform thickness. Thus, the coating layers of uniform thickness are formed on both the main surfaces of the substrate 2.

However, if a coating solution of high viscosity is applied, the coating layer becomes thicker at the outer peripheral edge thereof coating layer due to surface tension of the coating solution. If the coating layer is dried in this state to form a resist layer, thickness of the obtained resist layer becomes large at its outer peripheral edge. If such a substrate 2 having a coating layer whose thickness becomes large at its outer peripheral edge is used for the manufacture of a discrete magnetic recording medium in which an uneven configuration is formed with a stamper, the stamper will be raised at a central portion when pressed against a surface of the resist layer to transfer a pattern. As a result, the transferred pattern may become unclear.

In the double-sided coating apparatus 1 of the present embodiment, however, the rinsing treatment described above removes an excessive coating layer at the outer peripheral edge and provides a coating layer of uniform thickness.

As illustrated in FIG. 13, the rotation driving mechanism 3 first drives the rotation axis 12 to rotate at a predetermined rotational speed. The substrate 2 is then rotated in accordance with the rotational direction and the rotational speed of the rotation axis 12.

Next, the first pivot driving mechanism 17 drives the first nozzle pivot arm 16 to pivot so that the first rinsing solution ejection port 24 faces the outer peripheral edge of the upper surface of the substrate 2. Similarly, the second pivot driving mechanism 31 drives the second nozzle pivot arm 26 to pivot so that the second rinsing solution ejection port 30 faces the outer peripheral edge of the lower surface of the substrate 2.

Next, the rinsing solution supply unit 21 supplies the rinsing solution to the first and second rinsing solution nozzles 19 and 27 so that a predetermined amount of coating solution is ejected from the first and second rinsing solution ejection ports 24 and 30.

The first rinsing solution ejection port 24 applies the rinsing solution to the outer peripheral edge of the coating layer formed on the upper surface of the substrate 2. Simultaneously, the second rinsing solution ejection port 30 applies the rinsing solution to the outer peripheral edge of the coating layer formed on the lower surface of the substrate 2. In this manner, the rinsing solution is supplied to the outer peripheral edge of the coating layer formed on each of the main surfaces of the substrate 2 at the same time. The rinsing solution dissolves the coating solution partially.

The control section controls the ejection amount of the rinsing solution at the first and second rinsing solution ejection ports 24 and 30 independently.

The first rinsing solution ejection port 24 ejects the coating solution downward in an angled manner and the second rinsing solution ejection port 30 ejects the coating solution upward. Accordingly, the rinsing solution ejected from the ejection port 24 and the rinsing solution ejected from the ejection port 30 behave differently. Under the same condition for applying the rinsing solution (e.g., the ejection amount and the scan speed of the rinsing solution ejection ports), the amount of the rinsing solution reaching the upper surface and the lower surface of the substrate 2 becomes different.

In the double-sided coating apparatus 1 of the present embodiment, however, since the ejection amount of the rinsing solution at the first rinsing solution ejection port 24 and the ejection amount of the rinsing solution at the second rinsing solution ejection port 30 are controlled independently, these parameters can be independently determined so that a targeted supply amount of the rinsing solution can be provided on both the upper and lower surfaces of the substrate 2. Accordingly, the rinsing solution can be applied to both the upper and lower surfaces of the substrate 2 at the same time in the targeted supply amount.

The rotation driving mechanism 3 increases the rotational speed of the rotation axis 12 to a predetermined rotational speed. The substrate 2 is rotated in accordance with the rotational speed. Rotation of the substrate 2 is stopped accordingly. When the substrate 2 is rotated at a high speed, the rinsing solution applied to the outer peripheral edge of the coating layer is spun off the outer peripheral edge while partially dissolving the coating solution. Thus, the excessive coating layer at the outer peripheral edge is removed. Accordingly, a coating layer whose thickness is uniforna across the inner peripheral end to the outer peripheral end can be provided. The rotation driving mechanism 3 stops the rotation of the substrate 2 after a predetermined time has elapsed.

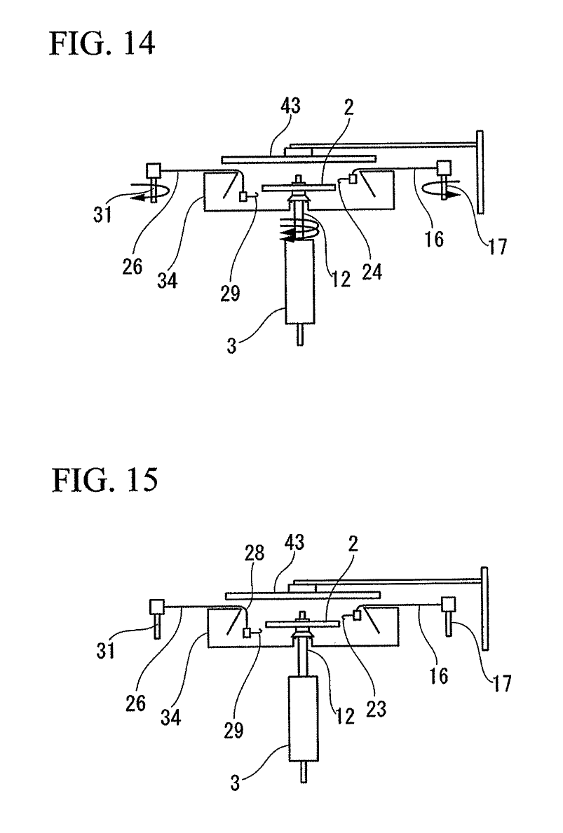

Next, as illustrated in FIG. 14, the first pivot driving mechanism 17 drives the first nozzle pivot arm 16 to pivot so that the first coating solution ejection port 24 is moved to the standby position. Similarly, the second pivot driving mechanism 31 drives the second nozzle pivot area 26 to pivot so that the second coating solution ejection port 29 is moved to the standby position.

Next, as illustrated in FIG. 15, the rotation driving mechanism 3 stops rotation of the rotation axis 12, Rotation of the substrate is stopped accordingly. As a result, as illustrated in FIG. 18, the resist layer (fox example, 200 nm-thick) 106 is provided on the surface of the magnetic layer 103.

In the double-sided coating apparatus I of the present embodiment, a uniform air flow is generated in the space surrounded by the cup housing 34 and the cover 43 in the preceding steps. Thus, the coating layer can be dried uniformly and adhesion of dust or other substances to the coating layer can be avoided.

Next, the pivot driving mechanism 42 drives the pivot arm 41 to pivot so that the cover 43 is moved to the open position from the closed position. Next, the cup housing movement mechanism 35 moves the cup housing 34 downward so that the cup housing 34 is moved to the non-housing position from the housing position.

Next, the first pivot driving mechanism 17 drives the first nozzle pivot arm 16 to pivot in the direction of arrow B₁ in FIG. 3A so that the first coating solution ejection port 23 is moved to the first (i.e., initial) position from the second (i.e., standby) position. Similarly, the second pivot driving mechanism 31 drives the second nozzle pivot arm 26 to pivot in the direction of arrow A₂ in FIG. 3A so that the second coating solution ejection port 29 is moved to the first (i.e., initial) position from the second (i.e., standby) position.

Next, the substrate 2 having the resist layers 106 formed on both the upper and lower surfaces thereof is removed from the rotation axis 12 of the double-sided coating apparatus 1.

As described above, in the double-sided coating apparatus 1 of the present embodiment, the coating solution can be applied to both the main surfaces of the substrate 2 at the same time from the first coating solution nozzle 18 which ejects the coating solution to the upper surface and from the second coating solution nozzle 28 which ejects the coating solution to the lower surface. Accordingly, different from a configuration in which the coating solution is applied to the first main surface and subsequently to the second main surface of the substrate 2, the coating solution can be applied to both the main surfaces of the substrate 2 in a simple process and in a short time.

Since the ejection amount of the coating solution and the scan speed of the first coating solution ejection port 23 and the ejection amount of the coating solution and the scan speed of the second coating solution ejection port 29 are controlled independently, the coating solution can be applied to both the main surfaces of the substrate 2 in substantially the same amount to form the coating layers of uniform thickness.

The double-sided coating apparatus 1 includes the first rinsing solution nozzle 19 which ejects the rinsing solution at the outer peripheral edge of the coating layer formed on the upper surface of the substrate 2 and the second rinsing solution nozzle 27 which ejects the rinsing solution at the outer peripheral edge of the coating layer formed on the lower surface of the substrate 2. With this configuration, even if a coating solution of high viscosity is used which may form a coating layer having excessively large thickness at the outer peripheral edge thereof due to surface tension, the excessive coating layer at the outer peripheral edge can be dissolved and removed.

In this manner, the resist layers 106 with unifonn thickness can be formed on both surfaces of the substrate 2 in a simple process and in a short time. Accordingly, when, for example, a stamper is pressed against the surface of the resist layer to transfer a pattern, the surface of the resist layer and the stamper are made to close contact to each other so as to transfer the pattern precisely to the resist surface.

In the double-sided coating apparatus 1 of the present embodiment, since the receiving section 11a of the chuck 11 which holds the substrate 2 has a device to close the central opening 2a of the substrate 2, ingress of the coating solution into the central opening 2a of the substrate 2 can be avoided during application of the coating solution. Thus, the resist layer 106 can be formed on the surface except for the central opening 2a.

Accordingly, a magnetic recording medium in which the substrate 2 is manufactured by fanning a magnetic layer on a non-magnetic substrate can be held precisely by a chuck of a recording/reproducing apparatus at the central opening and thus contamination of the chuck or other devices caused by the resist remaining in the central opening can be avoided.

Next, as illustrated in FIG. 19, the obtained resist layer 106 is patterned in a plane configuration in accordance with the magnetic recording pattern so as to provide the resist pattern 107.

The resist 106 layer can be patterned using, for example, a stamper which is directly pressed against the resist layer 106 from above and with high pressure. If UV curing resin is employed as the resist, the pattern can be formed through photolithography.

A stamper employed in the above process may have a fine track pattern formed by, for example, electron beam lithography, on a metal plate. Ni, which satisfies hardness and durability demands for the process described above, may be employed as a stamper. However, any materials may be employed as long as they achieve the object described above. In addition to the tracks for recording data, servo signal patterns, such as a burst pattern, a gray code pattern and a preamble pattern, can be formed with the stamp.

Next, magnetic property of the magnetic layer is modified in a portion in which no resist pattern 107 is formed to provide a portion in which the magnetic recording pattern is magnetically separated.

Magnetic property can be modified by, for example, exposing the magnetic layer with the resist pattern 107 formed thereon to reactive plasma.

Examples of the reactive plasma include inductively coupled plasma (ICF) and reactive ion plasma (RIE).

Next, the resist pattern 107 is removed from the magnetic layer 103.

The resist can be removed by, for example, dry etching, reactive ion etching, ion milling and wet etching.

Next, the protective film 105 and the lubricant layer are formed on the magnetic layer 103.

The protective film 105 is usually provided by forming a thin film of diamond-like carbon through P-CVD, but is not limited thereto. The lubricant layer can be formed by, for example, applying and then drying a lubricant-containing solution on a surface of the protective film.

As described above, in this manufacturing process, the magnetic recording medium is manufactured in the following steps: forming the resist pattern in accordance with the magnetic recording pattern on the surface of the magnetic layer; treating the surface with reactive plasma; removing the resist; re-forming the protective layer; and then applying a lubricant. Thus, reactivity between the magnetic layer and reactive plasma is increased.

As another approach, the magnetic recording medium may be manufactured in the following steps: forming the protective layer on the magnetic layer; forming a resist pattern in accordance with the magnetic recording pattern using the double-sided coating apparatus according to the invention; and then modifying magnetic layer using reactive plasma. In this manner, the need of forming the protective film after the reactive plasma treatment is eliminated and thus the manufacturing process becomes simple. Such a configuration provides an advantageous effect of improvement in productivity and reduction in contamination in the manufacturing process of the magnetic recording medium. The inventors confirmed through experiments that the magnetic layer and reactive plasma can be made to react with, each other even after the protective film is formed on the surface of the magnetic layer. According to the inventors, the magnetic layer, which is covered with the protective film, and reactive plasma are made to react with each other because the protective film has voids into which reactive ions in plasma enter and react with the magnetic metal. Alternatively, reactive ions may diffuse in the protective film and reach the magnetic layer.

### INDUSTRIAL APPLICABILITY

The invention can be incorporated in, for example, a double-sided coating apparatus which applies a coating solution to form resist layers on magnetic layers provided on both surfaces of a disc-shaped substrate having a. central opening.

1. A double-sided coating apparatus used to form a coating layer on both main surfaces of a substrate with a central opening by supplying a coating solution to the main surfaces, operating the substrate to rotate and causing the coating solution. to spread out on the main surfaces, the apparatus comprising:
a rotation driving mechanism which comprises a holding mechanism for holding the substrate at the central opening, the rotation driving mechanism driving the substrate to rotate in a circumferential direction;
a first solution coating unit which comprises a first coating solution nozzle through which the coating solution is ejected to a first main surface of the substrate and a moving mechanism for the first coating solution nozzle which operates the first coating solution nozzle to move so that a coating solution ejection port of the nozzle is moved to scan the first main surface while being kept away from the first main surface; and
a second solution coating unit which comprises a second coating solution nozzle through which the coating solution is ejected to a second main surface of the substrate and a moving mechanism for the second coating solution nozzle which operates the second coating solution nozzle to move so that a coating solution ejection port of the nozzle is moved to scan the second main surface while being kept away from the second main surface.

2. The double-sided coating apparatus according to claim 1, further comprising a device to close the central opening of the substrate to prevent ingress of the coating solution to the central opening when the substrate is held by the holding mechanism.

3. The double-sided coating apparatus according to claim 1, further comprising a control section for controlling an operation of the rotation driving mechanism, the first solution coating unit or the second solution coating unit, wherein the control section has a device to control the first coating solution nozzle operated by the moving mechanism for the first coating solution nozzle and the second coating solution nozzle operated by the moving mechanism for the second coating solution nozzle to eject the coating solution only to outside of an inner peripheral edge of the substrate held by the holding mechanism without ejecting the coating solution to the central opening of the substrate.

4. The double-sided coating apparatus according to claim 1, further comprising a control section for controlling an operation of the rotation driving mechanism, the first solution coating unit or the second solution coating unit, wherein the control section has a device to independently control an ejection amount of the coating solution from the first coating solution nozzle and an ejection amount of the coating solution from the second coating solution nozzle.

5. The double-sided coating apparatus according to claim 4, wherein the control section has a device to independently control the ejection amount of the coating solution from the first coating solution nozzle and a scan speed of the coating solution ejection port of that nozzle and the ejection amount of the coating solution from the second coating solution nozzle and a scan speed of the coating solution ejection port of that nozzle.

6. The double-sided coating apparatus according to claim 1, wherein: the first solution coating unit further comprises, around the holding mechanism, a first nozzle pivot arm which supports the first coating solution nozzle; the second solution coating unit further comprises, around the holding mechanism, a second nozzle pivot arm which supports the second coating solution nozzle; and the first and second coating solution nozzles are supported so that the coating solution ejection ports thereof face each of the main surfaces of the substrate as the first and the second pivot arms pivot along a surface parallel to the substrate.

7. The double-sided coating apparatus according to claim 6, wherein: the first nozzle pivot arm and the second nozzle pivot ann are disposed symmetric about the holding mechanism; and the coating solution ejection port of the first nozzle pivot arm and the coating solution ejection port of the second nozzle pivot arm are independently supported so as to be moved from an inner peripheral edge of the central opening of the substrate to an outer peripheral edge of the substrate.

8. The double-sided coating apparatus according to claim 1, further comprising a cup housing disposed to surround the substrate and the holding mechanism holding the substrate, wherein, the cup housing is moved close to or away from the substrate with an opening thereof facing the substrate and is moved between a non-housing position in which the opening of the cup housing is kept away from the substrate and a housing position in which the substrate is housed in the cup housing:

9. The double-sided coating apparatus according to claim 8, wherein:
the first and second coating solution nozzles are provided to extend from outside the cup housing so that coating solution ejection ports at their distal ends face the substrate; and
the distal end of the first coating solution nozzle and the distal end of the second coating solution nozzle are bent so that the first and second coating solution nozzles can be made to scan with the coating solution ejection ports at the distal ends thereof being close to the substrate through the opening of the cup housing when the cup housing is in a housing position in which the subsstrate is housed.

10. The double-sided coating apparatus according to claim 8, further comprising a cover for closing the opening of the cup housing via a slight clearance, the cover being moved close to or away from the cup housing in a state in which the substrate is housed in the cup housing and the coating solution ejection ports at the distal ends of the first and second coating solution nozzles are made to extend to face the substrate.

11. The double-sided coating apparatus according to claim 10, wherein, in a state in which a discharge pipe is connected to a bottom of the cup housing and the opening of the cup housing is closed with the cover via a slight clearance, air is sucked from outside into the cup housing through the clearance to generate an air flow from the opening toward the bottom of the cup housing.

12. The double-sided coating apparatus according to claim 11, further comprising a spreading-out slope plate disposed at an inner peripheral side of the opening of cup housing for guiding the flow of air sucked through the housing through the opening.

13. The double-sided coating apparatus according to claim 10, wherein: a rotation axis of the rotation driving mechanism penetrates the cup housing at a bottom center thereof; an air suction clearance is formed between the rotation axis and the bottom of the cup housing; a discharge pipe is connected to the bottom of the cup housing at an outer peripheral side thereof; an umbrella-shaped air control section is provided at the rotation axis to surround the clearance; and an outward air flow is generated along the bottom of the cup housing from the air suction clearance toward the discharge pipe.

14. The double-sided coating apparatus according to claim 1, wherein:
the first solution coating unit further comprises, adjacent to the first coating solution nozzle, a first rinsing solution nozzle for rinsing the coating solution applied to the substrate and the second solution coating unit further comprises, adjacent to the second coating solution nozzle, a nozzle for a second rinsing solution for ringing the coating solution applied to the substrate; and
these nozzles for the first and second rinsing solutions are provided to be movable along one of the first and second main surfaces of the substrate and the coating layers on the substrate is partially rinsed and removed by the rinsing solution ejected from the nozzles for the first and second rinsing solutions.

15. The double-sided coating apparatus according to claim 14, wherein, the rinsing solution is ejected in an angled direction toward an outer peripheral edge of the first main surface of the substrate through the rinsing solution ejection port in a state in which the distal end of the first rinsing solution nozzle faces the first main surface of the substrate held by the holding mechanism, and the rinsing solution is ejected in an angled direction toward the outer peripheral edge of the second main surface of the substrate through the rinsing solution ejection port in a state in which the first rinsing solution nozzle faces the second main surface of the substrate held by the holding mechanism.

16. A method for double-sided coating with a coating solution for forming coating layers on both main surfaces of a substrate with a central opening by supplying a coating solution to the main surfaces, operating the substrate to rotate and causing the coating solution to spread out on the main surfaces, the method comprising:
forming the coating layers on both the main surfaces of the substrate by keeping the substrate horizontally, ejecting a coating solution to both the main surfaces of the substrate from a first coating solution nozzle through which the coating solution is ejected to a first main surface of the substrate and a second coating solution nozzle through which the coating solution is ejected to a second main surface of the substrate and making the substrate rotate; and then
ejecting a rinsing solution to thick portions of the coating layers formed at an outer peripheral edge of the substrate from a first rinsing solution nozzle through which the rinsing solution is ejected to the first main surface and a second rinsing solution nozzle through which the rinsing solution is ejected to the second main surface and making the substrate rotate so that the thick portions of the coating layers are partially removed together with the rinsing solution to provide the coating layers of uniform thickness.

17. The method for double-sided coating with a coating solution according to claim 16, wherein, in a state in which both of a rinsing solution ejection port of the first rinsing solution nozzle and a rinsing solution ejection port of the second rinsing solution nozzle are positioned inside of the outer peripheral edge of the substrate, the rinsing solution is ejected in an angled direction from an inner peripheral portion toward the outer peripheral edge of the substrate and the rinsing solution is placed on the coating layers, and then the substrate is made to rotate so that the thick portions of the coating layers at the outer peripheral edge of the substrate are partially removed.

18. The method for double-sided coating with a coating solution according to claim 16, wherein the coating solution is ejected from the first and second coating solution nozzles with the substrate being kept horizontally and the central opening of the substrate being closed to prevent ingress of the coating solution.
